(19) United States
(12) Patent Application Publication
(10) Pub. No.: US 2019/0204948 A1
(43) Pub. Date: Jul. 4, 2019

(54) TOUCH ASSEMBLY, TOUCH SCREEN, AND DISPLAY PANEL

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Xiaodong Xie, Beijing (CN); Tsung Chieh Kuo, Beijing (CN); Lei Zhang, Beijing (CN); Jing Wang, Beijing (CN)

(21) Appl. No.: 16/022,050

(22) Filed: Jun. 28, 2018

(30) Foreign Application Priority Data
Jan. 3, 2018 (CN) 201810005683.8

(51) Int. Cl. G06F 3/044; G06F 3/041; G02F 1/133; G02F 1/1333; G02F 1/1343; G02F 1/1335

(52) U.S. Cl. CPC G06F 3/044; G06F 3/0412; G02F 1/13306; G02F 1/13338; G02F 1/134309; G02F 2001/133302; G02F 1/133528; G06F 2203/04102; G06F 2203/04103; G02F 2201/503; G02F 1/133514

(57) ABSTRACT

A touch assembly, a touch screen, and a display panel are provided. The touch assembly includes: a base substrate; and an electrode layer on the base substrate, wherein a plurality of driving electrodes and a plurality of touch sensing electrodes are formed in the electrode layer, and the plurality of touch sensing electrodes are insulated from the plurality of driving electrodes, and wherein at least one of the plurality of driving electrodes matches with at least one of the plurality of touch sensing electrodes to form mutual capacitance.

### CROSS-REFERENCE TO RELATED APPLICATION

This application claims the priority benefit of Chinese Patent Application No. 201810005683.8 filed on Jan. 3, 2018 in the State Intellectual Property Office of China, the disclosure of which is incorporated herein by reference in entirety.

### BACKGROUND

### Technical Field

Embodiments of the present disclosure relate to the field of touch technology, and in particular, to a touch assembly, a touch screen, and a display panel.

### Description of the Related Art

Currently, with the advent of popular consumer electronic products, people seek for electronic products with constantly increasing enthusiasm. Particularly popular products have been introduced that use a capacitive touch screen, which has an excellent touch function. At present, many touch screen manufacturers on the market have been working to keep pace with these popular products, such as the products manufactured by Apple Inc., and have introduced a variety of capacitive touch screens. With the development of capacitive touch screens, has come increasingly high requirements on their optical performance, electrical performance, appearance and cost. Under the same specification, if the cost of the capacitive touch screen is lower, higher profits may be obtained in the fierce competitive environment. It has become a research direction for those skilled in the art to reduce the cost of the capacitive touch screen.

### SUMMARY

An embodiment of the present disclosure provides a touch assembly, comprising: a base substrate; and an electrode layer on the base substrate, wherein a plurality of driving electrodes and a plurality of touch sensing electrodes are formed in the electrode layer, and the plurality of touch sensing electrodes are insulated from the plurality of driving electrodes, and wherein at least one of the plurality of driving electrodes matches with at least one of the plurality of touch sensing electrodes to form mutual capacitance.

In some embodiments, the plurality of touch sensing electrodes comprise a plurality of groups of touch sensing electrodes, each of the driving electrodes matches with one group of the plurality of groups of touch sensing electrodes to form mutual capacitance, and each group of the plurality of groups of touch sensing electrodes comprises at least two touch sensing electrodes.

In some embodiments, at least a portion of the touch sensing electrodes in each group of the plurality of groups of touch sensing electrodes are connected via one common electrode.

In some embodiments, all of the touch sensing electrodes in each group of the plurality of groups of touch sensing electrodes are connected via one common electrode.

In some embodiments, each of the driving electrodes extends in a first direction, each group of the plurality of groups of touch sensing electrodes are arranged in a column in the first direction, and the plurality of driving electrodes and the plurality of groups of touch sensing electrodes are alternately arranged in a second direction perpendicular to the first direction.

In some embodiments, each of the driving electrodes comprises a plurality of first matching portions arranged in a longitudinal direction of the driving electrode, each touch sensing electrode in each group of the plurality of groups of the touch sensing electrodes comprises a second matching portion that is complementary in shape to a corresponding one of the plurality of first matching portions, and each of the plurality of first matching portions matches with one second matching portion to form mutual capacitance.

In some embodiments, each of the plurality of first matching portions and the matched second matching portion are nested within each other.

In some embodiments, one of the first matching portion and the second matching portion comprises a hollow portion provided with an opening, and the other of the first matching portion and the second matching portion comprises a protrusion accommodated in the hollow portion.

In some embodiments, the first matching portion is separated from the matched second matching portion by an insulating material.

In some embodiments, output ends of the plurality of driving electrodes and output ends of the plurality of groups of touch sensing electrodes are arranged to form a finger-like terminal.

In some embodiments, the touch assembly further comprises a static electricity discharging line disposed in the electrode layer with the driving electrodes and the touch sensing electrodes, and insulated from the driving electrodes and the touch sensing electrodes.

In some embodiments, the base substrate is a glass substrate.

An embodiment of the present disclosure also provides a touch screen, comprising: the touch assembly as described above; and a touch integrated circuit, electrically connected to the touch assembly and configured to receive a touch sensing signal sent by the touch sensing electrodes and to determine a touch coordinate according to the touch sensing signal.

In some embodiments, the touch screen comprises a plurality of touch regions, each of the plurality of touch regions comprising at least one said touch assembly, each touch assembly being electrically connected to the touch integrated circuit.

In some embodiments, the touch assemblies in all touch regions share a same base substrate.

In some embodiments, the touch integrated circuit comprises a plurality of flexible circuit boards, and each of the plurality of touch regions is electrically connected to at least one of the plurality of flexible circuit boards.

An embodiment of the present disclosure also provides an Oncell touch screen, comprising: the touch assembly as described above; and a black matrix layer between the electrode layer and the base substrate.

An embodiment of the present disclosure also provides a display panel, comprising: an array substrate and a color filter substrate opposite to each other; a polarizer on a side of the color filter substrate away from the array substrate; and the touch assembly as described above, wherein the touch assembly is between the color filter substrate and the polarizer, and the base substrate of the touch assembly functions as a base substrate of the color filter substrate.

In some embodiments, the base substrate is a glass substrate.

### BRIEF DESCRIPTION OF THE DRAWINGS

FIG. 1 is a front view of a touch assembly according to an embodiment of the present disclosure;

FIG. 2 is an enlarged view of part A of FIG. 1;

FIG. 2A is a cross-sectional view of the touch assembly taken along a line B-B of FIG. 2;

FIG. 3 is a partial view of a touch assembly according to another embodiment of the present disclosure;

FIG. 4 is a front view of a touch assembly according to a further embodiment of the present disclosure;

FIG. 5 is a schematic structural view of a combination of a plurality of touch assemblies according to an embodiment of the present disclosure;

FIG. 6 is a schematic cross-sectional view of a touch substrate with an OGS (One Glass Solution) structure according to an embodiment of the present disclosure; and

FIG. 7 is a schematic cross-sectional view of a touch substrate with a single layer on cell (referred to as SLOC or Oncell) structure according to an embodiment of the present disclosure.

### DETAILED DESCRIPTION OF EMBODIMENTS

In order to enable those skilled in the art to understand technical solutions of the present disclosure, the present disclosure will be described in detail below with reference to the accompanying drawings and the specific embodiments.

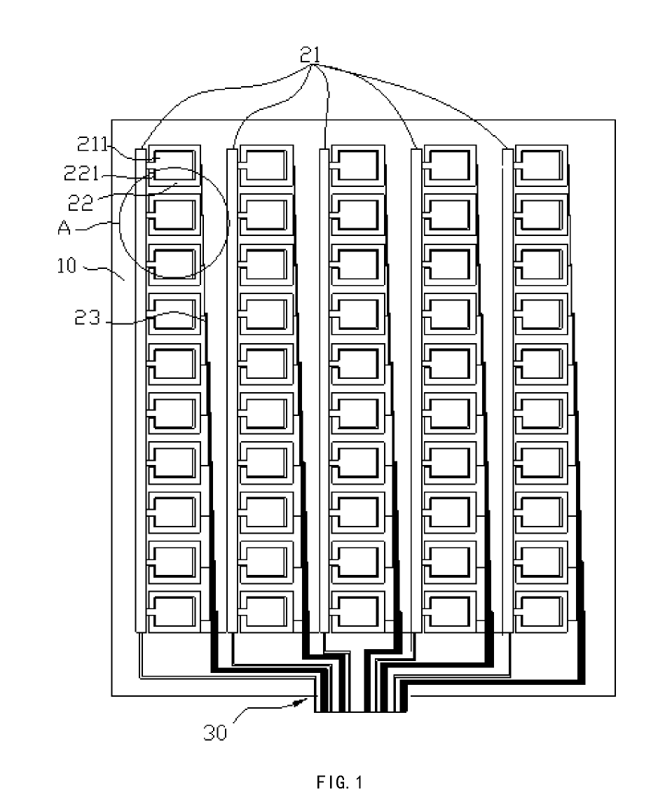

As shown in FIGS. 1 to 5, an embodiment of the present disclosure discloses a touch assembly, including a base substrate 10 (e.g., a glass substrate) and an electrode layer 20 disposed on the base substrate 10. A plurality of driving electrodes 21 and a plurality of touch sensing electrodes 22 are formed in the electrode layer 20. That is, the plurality of driving electrodes 21 and the plurality of touch sensing electrodes 22 are disposed in a same layer. The phrase “disposed in a same layer” described herein means that the driving electrodes and the touch sensing electrodes are simultaneously formed in the same process step. The “same layer” does not mean that the driving electrodes and the touch sensing electrodes have the same layer thickness or layer height in the cross section thereof. Further, the plurality of driving electrodes 21 are insulated from the plurality of touch sensing electrodes 22. In the embodiment shown in FIG. 1, the plurality of touch sensing electrodes 22 include a plurality of groups of touch sensing electrodes 22, and each group of touch sensing electrodes 22 includes a plurality of touch sensing electrodes 22, and each of the driving electrodes 21 corresponds to one group of touch sensing electrodes 22, that is, each of the plurality of driving electrodes 21 matches with one group of touch sensing electrodes 22, to form mutual capacitance. As an example, each group of touch sensing electrodes 22 may be arranged in a row or a column. However, the embodiments of the present disclosure are not limited thereto, as long as at least one of the plurality of driving electrodes 21 matches with at least one of the plurality of touch sensing electrodes 22 to form mutual capacitance between the driving electrode 21 and the touch sensing electrode 22. As an example, the driving electrodes 21 and the touch sensing electrodes 22 may both be made of a transparent conductive material, for example indium tin oxide (ITO).

According to the touch assembly disclosed in the embodiment of the present disclosure, on the one hand, since the plurality of driving electrodes 21 and the plurality of groups of touch sensing electrodes 22 are disposed in the same layer, they may be formed by one patterning process, so that mutual-capacitance touch can be realized by one film (for example ITO film), thus it can effectively reduce manufacturing cost of the touch assembly, compared to the arrangement of multiple layers for forming the mutual-capacitance touch. On the other hand, one drive electrode 21 corresponds to a group of touch sensing electrodes 22, in this way, it can greatly optimize electrode arrangement, and make the electrode arrangement simpler and more efficient.

In an embodiment of the present disclosure, as shown in FIG. 1, all of the touch sensing electrodes 22 in each group of touch sensing electrodes 22 are connected via one common electrode 23. In this embodiment, the electrical connection of all the touch sensing electrodes 22 of each group of touch sensing electrodes 22 via one common electrode 23 enables to greatly reduce the number of wiring pins of the touch sensing electrodes 22, thereby saving occupation area of the wiring pins. However, the embodiments of the present disclosure are not limited thereto, for example, it is also possible to configure that some of the touch sensing electrodes 22 in each group of touch sensing electrodes 22 are connected via one common electrode 23.

There may be various arrangements of the driving electrodes 21 and the touch sensing electrodes 22. In an embodiment of the present disclosure, as shown in FIG. 1, the plurality of driving electrodes 21 are arranged in a row, each driving electrode 21 extends in a first direction (column direction), each group of touch sensing electrodes 22 are arranged in a column along the first direction, and the plurality of driving electrodes 21 and the plurality of groups of touch sensing electrodes 22 are alternately arranged in a second direction (row direction) perpendicular to the first direction, for example, such that the driving electrodes 21 and the touch sensing electrodes 22 are arranged in a matrix. In this embodiment, each of the plurality of driving electrodes 21 is in an elongated shape, the plurality of elongated driving electrodes 21 are sequentially arranged, and the touch sensing electrodes 22 are in a rectangular shape, each group of touch sensing electrodes 22 are located between two adjacent driving electrodes 21, each group of touch electrodes correspond to (match with) the drive electrode 21 on a side thereof. Each group of touch sensing electrodes 22 are uniformly arranged in a longitudinal direction of the drive electrode 21, and the common electrode 23 is located at a side of each group of sensing electrodes 22 opposite to their corresponding driving electrode 21.

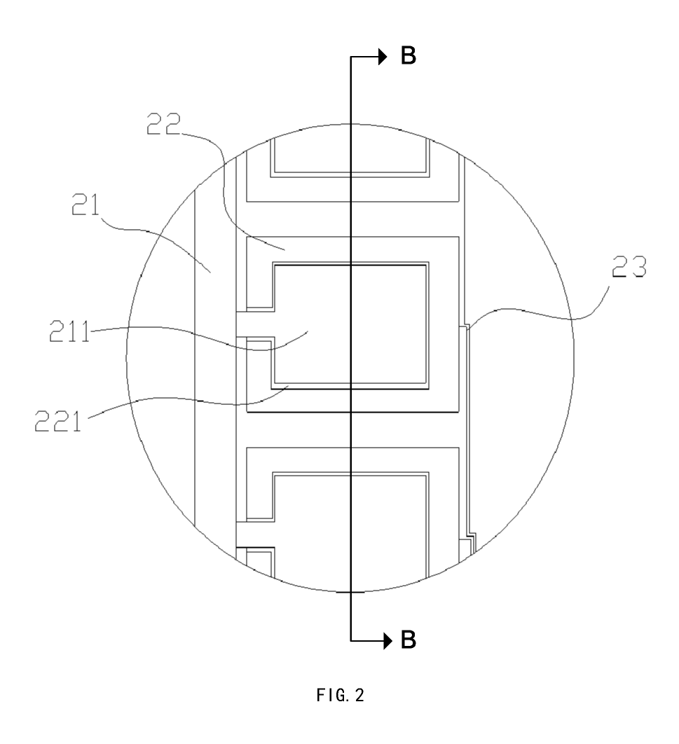

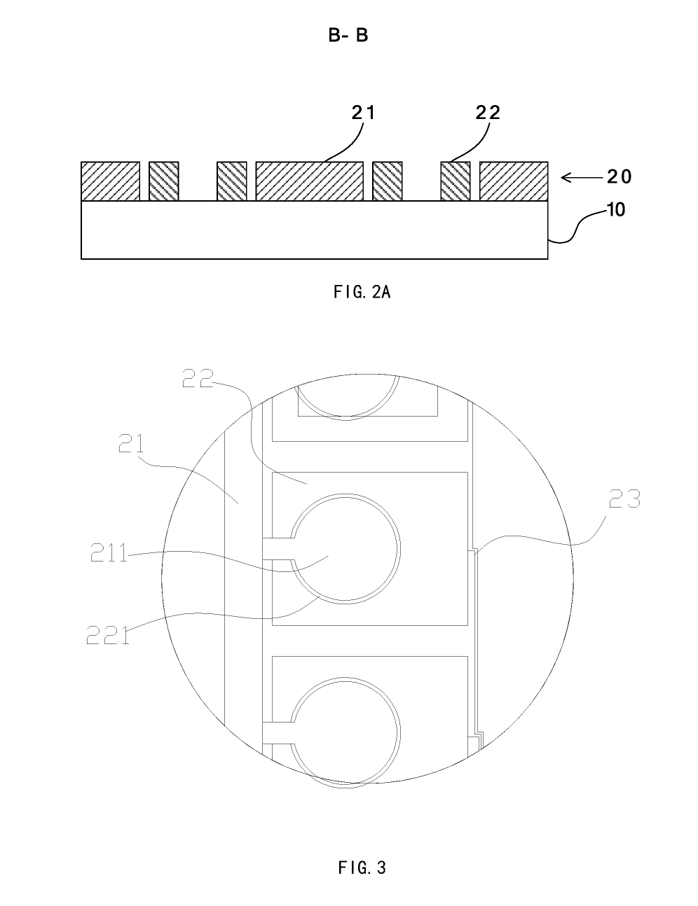

In an embodiment of the present disclosure, as shown in FIG. 2 and FIG. 3 in combination with FIG. 1, each of the plurality of driving electrodes 21 includes a plurality of first matching portions 211, the plurality of first matching portions 211 being arranged in a longitudinal direction of the driving electrode 21. Each touch sensing electrode 22 includes a second matching portion 221. For example, the first matching portion 211 and the second matching portion 221 are complementary in shape. Each of the first matching portions 211 matches with one second matching portion 221 to form mutual capacitance. For example, each of the first matching sections 211 and the matched second matching portion 221 are nested within each other. As an example, the second matching portions 221 of each group of touch sensing electrodes 22 is in one-to-one correspondence with the plurality of first matching portions 211 of each driving electrode 21. In this embodiment, the driving electrode 21 and the touch sensing electrodes 22 are arranged in a nested manner, thus interaction area between the touch driving electrode 21 and the touch sensing electrodes 22 is relatively large, thereby effectively improving touch effect.

As an example, one of the first matching portion 211 and the second matching portion 221 includes a hollow portion provided with an opening, and the other of the first matching portion 211 and the second matching portion 221 includes a protrusion accommodated in the hollow portion. The driving electrode 21 and the touch sensing electrodes 22 may be of a mutually nested structure in various types. For example, as shown in FIG. 3, a circular hollow portion is provided in the touch sensing electrode 22 to form the second matching portion 221 of the touch sensing electrode 22, and a circular disk that is slightly smaller than the circular hollow portion is connected to the driving electrode 21. The circular disk is nested in the circular hollow portion, and a certain gap is formed between the circular disk and the hollow portion so as to provide a better insulation effect. Alternatively, a circular hollow portion is provided in the drive electrode 21 to form the first matching portion 211 of the driving electrode 21, and a circular disk is connected to the touch sensing electrode 22. The circular disk on the touch sensing electrode 22 is nested in the hollow portion of the driving electrode 21. For another example, as shown in FIG. 2, a rectangular hollow portion is provided in the touch sensing electrode 22 to form the second matching portion 221 of the touch sensing electrode 22, and a rectangular plate that is slightly smaller than the rectangular hollow portion is connected to the driving electrode 21. The rectangular plate is nested in the rectangular hollow portion, and a certain gap is formed between the rectangular plate and the hollow portion so as to provide a better insulation effect. Alternatively, a rectangular hollow portion is provided in the drive electrode 21 to form the first matching portion 211 of the driving electrode 21, and a rectangular plate is connected to the touch sensing electrode 22. The rectangular plate on the touch sensing electrode 22 is nested in the hollow portion of the driving electrode 21. As an example, the first matching portion 211 may be separated from the matched second matching portion 221 by an insulating material, to achieve a better insulation effect.

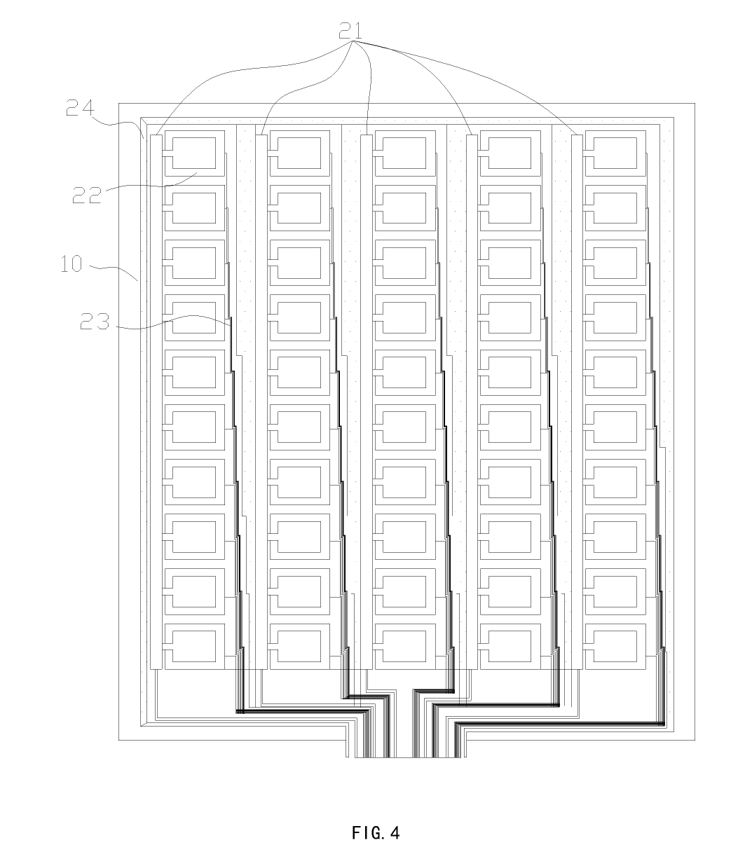

In an embodiment of the present disclosure, as shown in FIG. 4, the touch assembly further includes a static electricity discharging line 24 disposed in the same layer (that is, in the electrode layer 20) as the driving electrodes 21 and the touch sensing electrodes 22 and insulated from the driving electrodes 21 and the touch sensing electrodes 22. In an embodiment of the present disclosure, the static electricity discharging line 24 is in a comb shape, and it includes a comb ridge with a shape of “ [symbol] ” disposed on the periphery of a touch region and comb teeth disposed inside the touch region and connected to the comb ridge. The comb ridge surrounds three sides of the touch region. The static electricity discharging line 24 with this structure is uniformly distributed and has excellent static electricity discharging performance. Of course, the static electricity discharging line 24 with other structures may be used in the embodiments of the present disclosure.

In an embodiment of the present disclosure, as shown in FIG. 1, output ends of the plurality of driving electrodes 21 and output ends of the plurality of groups of touch sensing electrodes 22 are arranged to form a finger-like terminal 30, and the terminal 30 is connected to a touch integrated circuit (Touch IC). In this embodiment, the output ends of the driving electrodes 21 and the output ends of the plurality of groups of touch sensing electrodes 22 are arranged to form the terminal 30, thereby they may be conveniently connected to the touch integrated circuit in a plug-in manner.

The touch assembly according to the embodiments of the present disclosure can be made into a touch screen with an Oncell structure or an OGS structure.

As shown in FIG. 6, the touch screen includes the touch assembly as described above (a base substrate 81 and an electrode layer 83 are shown in FIG. 6) and a black matrix layer 82. The black matrix layer 82 is located between the electrode layer 83 and the base substrate 81. Herein, the black matrix layer 82 is configured to block light.

A manufacturing method of a touch substrate with an OGS structure may include:

Forming a pattern of the black matrix 82 on the base substrate 81, specifically including: applying photoresist, exposing it to a light, developing, etching, and the like.

Forming an ITO film layer, and then applying photoresist, exposing it to a light, developing, etching, stripping photoresist, and the like, and forming a desired pattern of the driving electrodes 21 and the touch sensing electrodes 22 in the electrode layer 83.

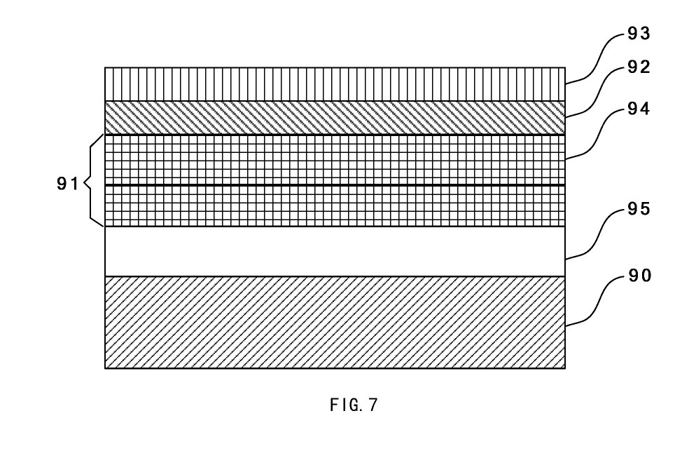

As shown in FIG. 7, the touch screen includes an array substrate 90 and a color filter substrate 91 opposite to each other, a polarizer 93, and a touch assembly as described above (an electrode layer 92 is shown in FIG. 7, the base substrate 94 of the touch assembly functions as the base substrate 94 of the color filter substrate 91. The driving electrodes 21 and the touch sensing electrodes 22 are formed in the electrode layer 92. The polarizer 93 is located on a side of the color filter substrate 91 away from the array substrate 90. The touch assembly is located between the color filter substrate 91 and the polarizer 93, and the base substrate 94 of the touch assembly functions as the base substrate 94 of the color filter substrate. A structure such as a liquid crystal layer 95 may be provided between the array substrate 90 and the color filter substrate 91.

A method of manufacturing a touch substrate with an OGS structure may include:

Forming an ITO film layer on the color filter substrate 91, and then applying photoresist, exposing it to a light, developing, etching, stripping photoresist, and the like, and forming the desired driving electrodes 21 and touch sensing electrodes 22 in the electrode layer 92.

Attaching a polarizer 93 above the electrode layer 92.

An embodiment of the present disclosure further discloses a touch screen, including the touch assembly as described above and a touch integrated circuit. The touch integrated circuit is electrically connected to the touch assembly, and is configured to receive a touch sensing signal sent by the touch sensing electrode and determine a touch coordinate according to the touch sensing signal.

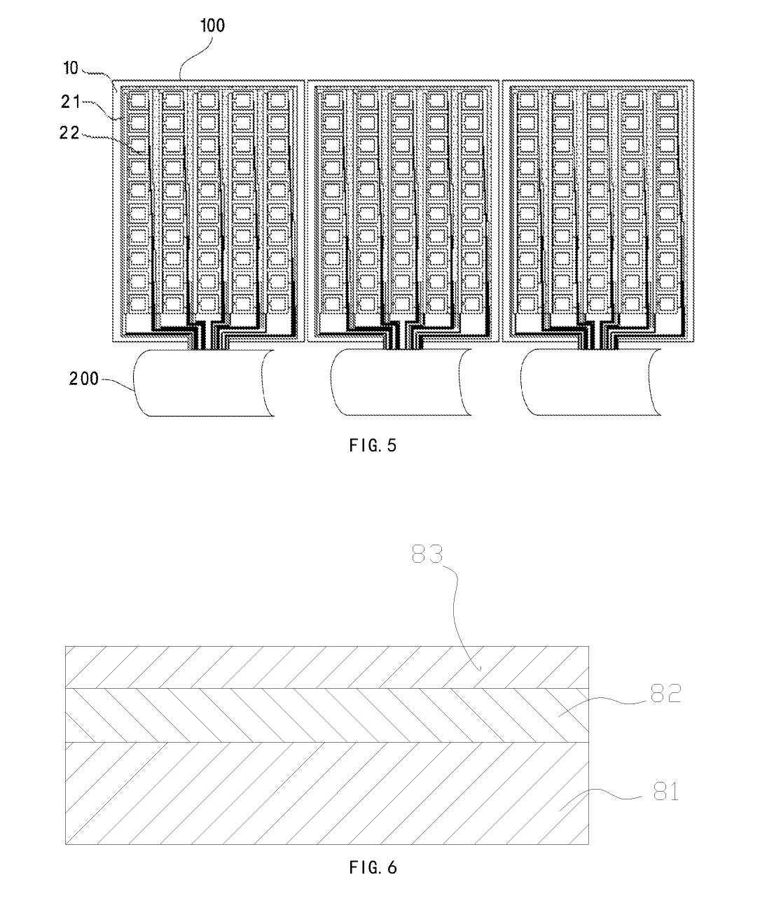

In an embodiment of the present disclosure, as shown in FIG. 5, the touch screen includes a plurality of touch assemblies 100. The plurality of touch assemblies 100 are sequentially connected by a substrate 10 thereon so that the touch screen includes a plurality of touch regions. In this embodiment, the plurality of touch assemblies are spliced to form a touch screen, so that the touch screen can be larger, thereby a large-size touch screen can be made more simply. In this embodiment, each of the spliced touch assemblies 100 is connected with a corresponding touch integrated circuit. As an example, each touch region includes at least one touch assembly 100, and the touch assemblies 100 in all the touch regions share the same substrate.

As an example, the touch integrated circuit includes a plurality of flexible circuit boards 200, and each touch region is electrically connected to at least one of the plurality of flexible circuit boards 200.

In order to save the number of touch integrated circuits, the touch assemblies may be in one-to-one correspondence to the flexible circuit boards (FPC). If each touch region corresponds to one flexible circuit board, the plurality of flexible circuit boards corresponding to the plurality of touch regions are connected to the same touch integrated circuit.

The above embodiments of the present disclosure are merely exemplary, and are not intended to limit the present disclosure. The scope of the present disclosure is defined by the claim set. Various modifications or equivalent substitutions may be made to the present disclosure by those skilled in the art within the spirit and scope of the present disclosure, and such modifications or equivalent substitutions should fall within the scope of the present disclosure.

What is claimed is:

1. A touch assembly, comprising:
a base substrate; and
an electrode layer on the base substrate,
wherein a plurality of driving electrodes and a plurality of touch sensing electrodes are formed in the electrode layer, and the plurality of touch sensing electrodes are insulated from the plurality of driving electrodes, and
wherein at least one of the plurality of driving electrodes matches with at least one of the plurality of touch sensing electrodes to form mutual capacitance.

2. The touch assembly according to claim 1, wherein the plurality of touch sensing electrodes comprises a plurality of groups of touch sensing electrodes, each of the driving electrodes matches with one group of the plurality of groups of touch sensing electrodes to form mutual capacitance, and each group of the plurality of groups of touch sensing electrodes comprises at least two touch sensing electrodes.

3. The touch assembly according to claim 2, wherein at least a portion of the touch sensing electrodes in each group of the plurality of groups of touch sensing electrodes are connected via one common electrode.

4. The touch assembly according to claim 3, wherein all of the touch sensing electrodes in each group of the plurality of groups of touch sensing electrodes are connected via one common electrode.

5. The touch assembly according to claim 2, wherein each of the driving electrodes extends in a first direction, each group of the plurality of groups of touch sensing electrodes are arranged in a column in the first direction, and the plurality of driving electrodes and the plurality of groups of touch sensing electrodes are alternately arranged in a second direction perpendicular to the first direction.

6. The touch assembly according to claim 2, wherein each of the driving electrodes comprises a plurality of first matching portions arranged in a longitudinal direction of the driving electrode, each touch sensing electrode in each group of the plurality of groups of the touch sensing electrodes comprises a second matching portion that is complementary in shape to a corresponding one of the plurality of first matching portions, and each of the plurality of first matching portions matches with one second matching portion to form mutual capacitance.

7. The touch assembly according to claim 6, wherein each of the plurality of first matching portions and the matched second matching portion are nested within each other.

8. The touch assembly according to claim 6, wherein one of the first matching portion and the second matching portion comprises a hollow portion provided with an opening, and the other of the first matching portion and the second matching portion comprises a protrusion accommodated in the hollow portion.

9. The touch assembly according to claim 6, wherein the first matching portion is separated from the matched second matching portion by an insulating material.

10. The touch assembly according to claim 2, wherein output ends of the plurality of driving electrodes and output ends of the plurality of groups of touch sensing electrodes are arranged to form a finger-like terminal.

11. The touch assembly according to claim 1, further comprising a static electricity discharging line disposed in the electrode layer with the driving electrodes and the touch sensing electrodes, and insulated from the driving electrodes and the touch sensing electrodes.

12. The touch assembly according to claim 1, wherein the base substrate is a glass substrate.

13. A touch screen, comprising:
the touch assembly according to claim 1; and
a touch integrated circuit, electrically connected to the touch assembly and configured to receive a touch sensing signal sent by the touch sensing electrodes and to determine a touch coordinate according to the touch sensing signal.

14. The touch screen according to claim 13, comprising a plurality of touch regions, each of the plurality of touch regions comprising at least one said touch assembly, each touch assembly being electrically connected to the touch integrated circuit.

15. The touch screen according to claim 13, wherein the touch assemblies in all touch regions share a same base substrate.

16. The touch screen according to claim 13, wherein the touch integrated circuit comprises a plurality of flexible circuit boards, and each of the plurality of touch regions is electrically connected to at least one of the plurality of flexible circuit boards.

17. An Oncell touch screen, comprising:
the touch assembly according to claim 1; and
a black matrix layer between the electrode layer and the base substrate.

18. A display panel, comprising:
an array substrate and a color filter substrate opposite to each other;
a polarizer on a side of the color filter substrate away from the array substrate; and
the touch assembly according to claim 1,
wherein the touch assembly is between the color filter substrate and the polarizer, and the base substrate of the touch assembly functions as a base substrate of the color filter substrate.

19. The display panel according to claim 18, wherein the base substrate is a glass substrate.
